(19) United States
(12) Patent Application Publication
(10) Pub. No.: US 2025/0315363 A1
(43) Pub. Date: Oct. 9, 2025

(54) IDENTIFYING BUG-INDUCING PULL REQUESTS FOR REPORTED BUGS

(71) Applicant: Microsoft Technology Licensing, LLC, Redmond, WA (US)

(72) Inventors: Shubham AGARWAL, Bengaluru (IN); Anil PRABHU, Bengaluru (IN); Apoorv Prakash PATWARDHAN, Bengaluru (IN); Nishant KUMAR, Bengaluru (IN); Srikant Rao DHAIPHULE, Bengaluru (IN)

(21) Appl. No.: 18/628,658

(22) Filed: Apr. 5, 2024

(51) Int. Cl. G06F 11/36

(52) U.S. Cl. CPC G06F 11/362

(57) ABSTRACT

Example solutions for identifying bug-inducing pull requests (PRs) for reported bugs are disclosed. PRs are summarized and scored for risk of causing a bug, and this information is stored in a database. Upon a report of a bug, the reported bug is classified and a ranked list of PRs that are likely to have caused the reported bug is generated, using the PR summaries and risk scores retrieved from the database. This enables tasking the correct team to resolve the reported bug. Examples use artificial intelligence (AI) for the various tasks of characterizing the reported bug, ranking the PRs in order of likelihood of having caused the reported bug, summarizing the PRs, and assigning risk scores to the PRs.

### BACKGROUND

Identifying the source of a bug in large and complex software projects with multiple repositories, pull requests (PRs), and teams is a challenging and time-consuming task. A PR is a proposal to merge a set of changes from one branch into another, typically used in large and complex software projects, in which configuration management of the project is highly important. For a PR, collaborators in the project review and discuss the proposed set of changes before the changes are integrated into the main codebase.

Unfortunately, however, PRs can introduce bugs that affect the functionality, performance, or security of the software. Bugs are reported by users, testers, or developers in a bug tracking system, such as Azure DevOps, Jira, or GitHub Issues. Bugs usually have a title and a description that provide information about the problem, the expected and actual behavior, the steps to reproduce, the environment, or the severity. Bugs are also manually assigned to an area path and a repository, which are hierarchical classifications of the work item by its functional or logical group and its code location, respectively.

### SUMMARY

The disclosed examples are described in detail below with reference to the accompanying drawing figures listed below. The following summary is provided to illustrate some examples disclosed herein.

Example solutions for identifying bug-inducing pull requests (PRs) for reported bugs: identify a plurality of pull requests (PRs) associated with bug fixes; label files of the plurality of PRs for training, the files of the plurality of PRs including PR summaries; assign risk of introducing a bug (RIB) scores to the labeled files of the plurality of PRs; and train a PR risk predictor, using the RIB scores and the labeled files of the plurality of PRs, to assign an aggregate risk score to a first PR.

Additional examples: receive a bug report for a reported bug; determine, from at least the bug report, a classification for the reported bug; query a PR database to identify a set of candidate PRs, having a potential association with the reported bug, based on at least the classification of the reported bug; rank the set of candidate PRs according to a likelihood of each PR of the set of candidate PRs having caused the reported bug; generate a bug remediation task report for the reported bug, the bug remediation task report including the set of candidate PRs and the ranking of the set of candidate PRs; and transmit the bug remediation task report to a remediation entity.

Additional examples: receive a plurality of PRs, wherein each PR of the plurality of PRs comprises a title, a description, an indication of changed files and/or changed code, an area path, and a merge date; and for each PR of the plurality of PRs: generate a PR summary; generate a risk score using historical bug data and historical PR data, the risk score indicating a likelihood of introducing a bug; and store the PR summary and the risk score in a PR database, associated with the PR.

### BRIEF DESCRIPTION OF THE DRAWINGS

The disclosed examples are described in detail below with reference to the accompanying drawing figures listed below:

FIG. 1 illustrates an example architecture that advantageously identifies bug-inducing pull requests (PRs) for reported;

FIG. 2 illustrates an exemplary training arrangement for training components of the architecture of FIG. 1;

FIG. 3 illustrates an exemplary PR, as may be used in examples of the architecture of FIG. 1;

FIG. 4 illustrates exemplary operations for generating a PR summary, as may occur when using an example of the architecture of FIG. 1;

FIG. 5 illustrates an exemplary PR summary, as may be used in examples of the architecture of FIG. 1;

FIG. 6 illustrates exemplary operations for generating a PR risk score, as may occur when using an example of the architecture of FIG. 1;

FIG. 7 illustrates an exemplary bug report, as may be used in examples of the architecture of FIG. 1;

FIG. 8 illustrates exemplary operations for determining a bug classification, as may occur when using an example of the architecture of FIG. 1;

FIG. 9 illustrates exemplary operations for identifying a set of candidate PRs that may have caused the reported bug of FIG. 7;

FIG. 10 illustrates exemplary operations for ranking the set of candidate PRs identified in FIG. 9, as to the likelihood of having caused the reported bug of FIG. 7;

FIG. 11 illustrates an exemplary bug remediation task report, as may be used in examples of the architecture of FIG. 1;

FIGS. 12, 13 and 14 show flowcharts illustrating exemplary operations that may be performed when using example architectures, such as the architecture of FIG. 1; and

FIG. 16 shows a block diagram of an example computing device suitable for implementing some of the various examples disclosed herein.

Corresponding reference characters indicate corresponding parts throughout the drawings.

### DETAILED DESCRIPTION

Example solutions for identifying bug-inducing pull requests (PRs) for reported bugs are disclosed. PRs are summarized and scored for risk of causing a bug, and this information is stored in a database. Upon a report of a bug, the reported bug is classified and a ranked list of PRs that are likely to have caused the reported bug is generated, using the PR summaries and risk scores retrieved from the database. This enables tasking the correct team to resolve the reported bug. Examples use artificial intelligence (AI) for the various tasks of characterizing the reported bug, ranking the PRs in order of likelihood of having caused the reported bug, summarizing the PRs, and assigning risk scores to the PRs. Automatically listing the probable PRs that might have induced the bug can help developers to understand the root cause, fix the bug, and prevent similar bugs in the future in a shorter time.

Aspects of the disclosure solve multiple problems that are necessarily rooted in computer technology and render computing platforms, which rely on software for proper functioning, more reliable and easier to use, by providing the practical result of facilitating resolution of software errors. This is accomplished, at least in part by, querying a PR database to identify a set of candidate PRs, having a potential association with the reported bug, based on at least the classification of the reported bug; and ranking the set of candidate PRs according to a likelihood of each PR of the set of candidate PRs having caused the reported bug.

The various examples will be described in detail with reference to the accompanying drawings. Wherever preferable, the same reference numbers will be used throughout the drawings to refer to the same or like parts. References made throughout this disclosure relating to specific examples and implementations are provided solely for illustrative purposes but, unless indicated to the contrary, are not meant to limit all examples.

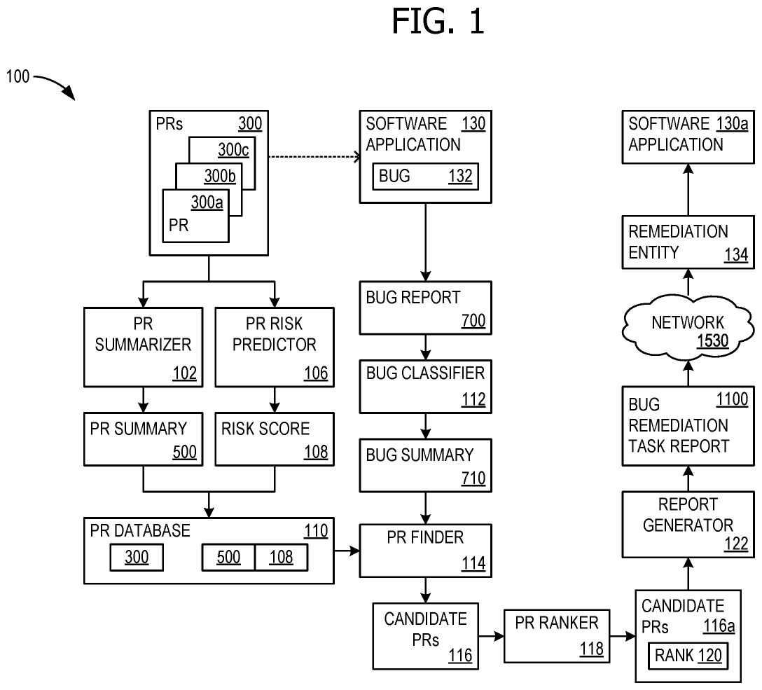

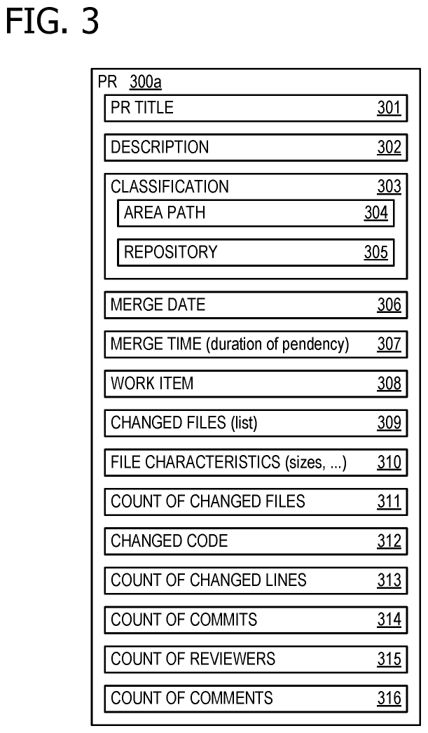

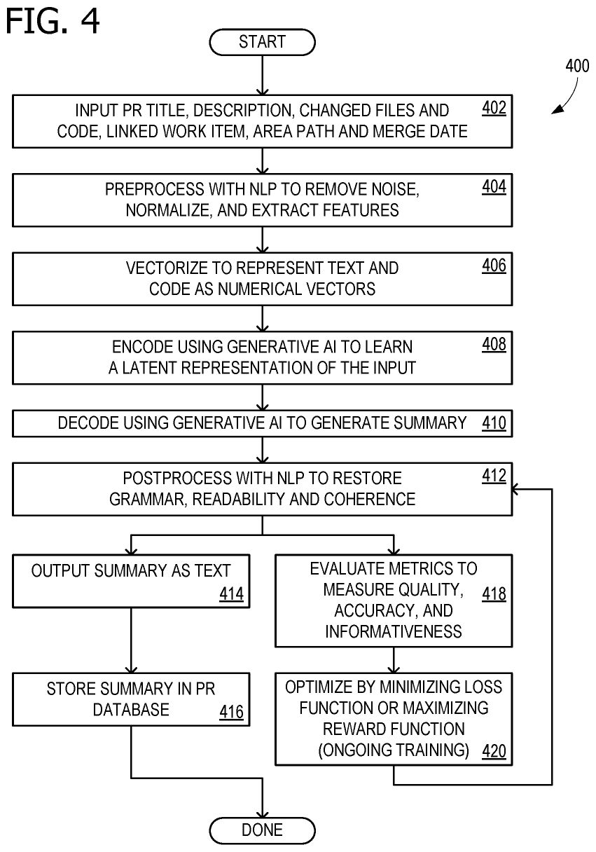

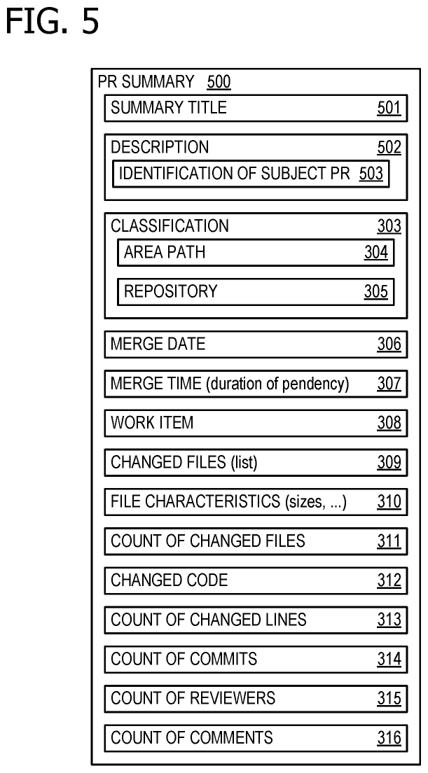

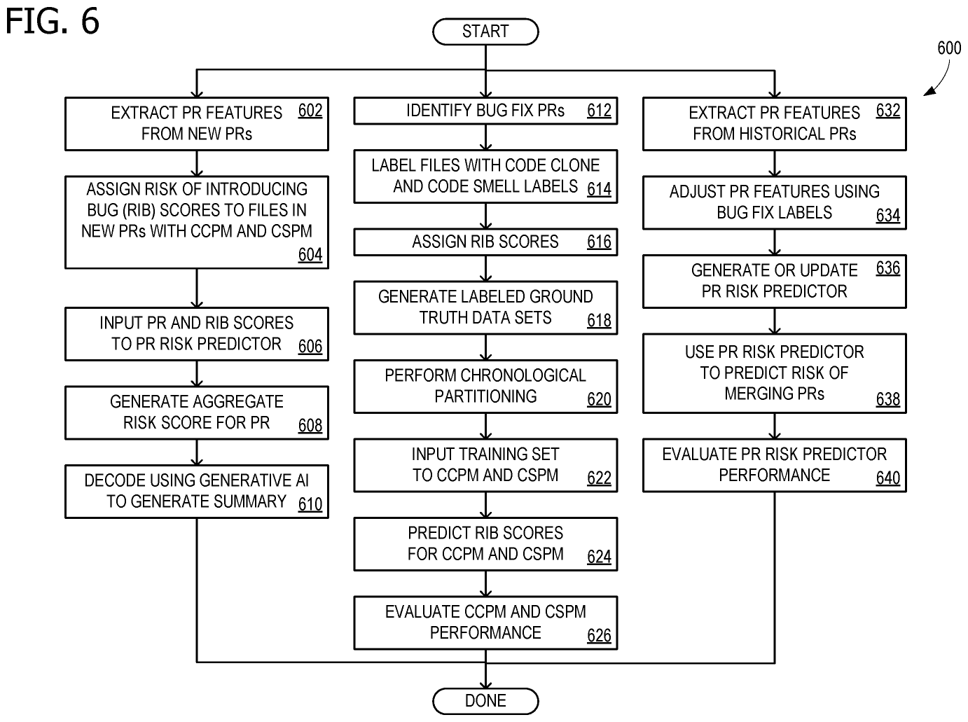

FIG. 1 illustrates an example architecture 100 that advantageously identifies bug-inducing PRs for reported bugs. A plurality of PRs 300, including a PR 300a, a PR 300b, a PR 300c, and others, is provided to a PR summarizer 102 and a PR risk predictor 106. For each PR, PR summarizer 102 generates a PR summary (e.g., PR summary 500 for PR 300a) and PR risk predictor 106 generates a risk score (e.g., risk score 108 for PR 300a). Risk score 108 indicates a likelihood of the subject PR introducing a bug. PR 300a is shown in further detail in FIG. 3, a process for generating PR summary 500 is shown in FIG. 4, PR summary 500 is shown in further detail in FIG. 5, and a process for generating risk score 108 is shown in FIG. 6. Plurality of PRs 300 are stored in PR database 110, along with PR summary 500 associated with risk score 108 (for PR 300a), and PR summaries associated with risk scores for other PRs of plurality of PRs 300.

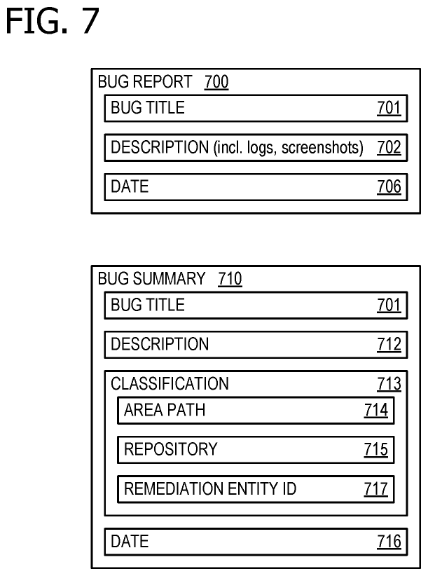

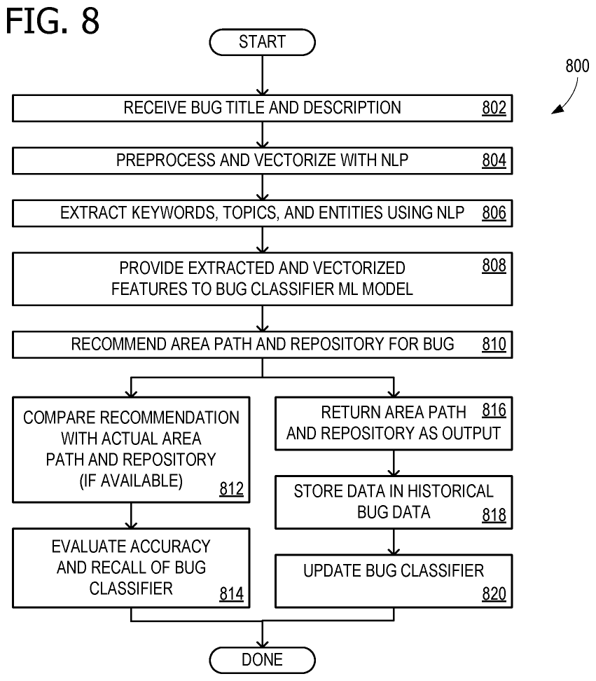

A software application 130 is created using plurality of PRs 300, and distributed to users. However, a reported bug 132 is encountered. A bug report 700 is generated for reported bug 132, and provided to a bug classifier 112, which produces a bug summary 710. Bug report 700 and bug summary 710 are shown in further detail in FIG. 7, and a process for generating bug summary 710 is shown in FIG. 8.

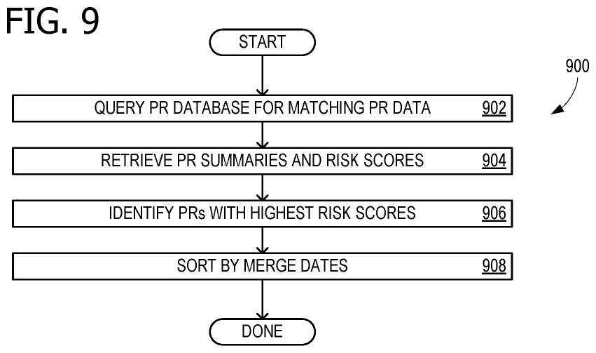

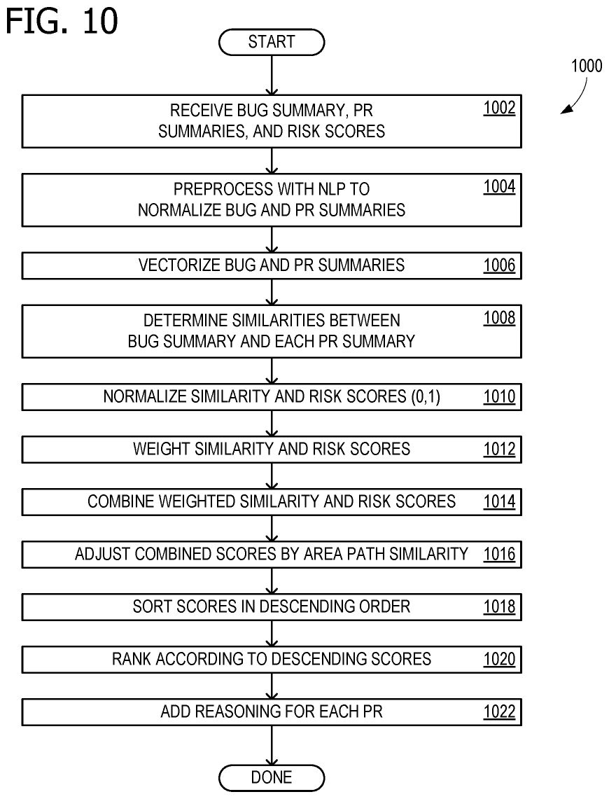

A PR finder 114 queries PR database 110 to identify a set of candidate PRs 116 that may have caused reported bug 132, and in the example described below, includes PR 300a. A PR ranker 118 ranks set of candidate PRs 116 according to a likelihood of having caused reported bug 132, to produce a ranked set of candidate PRs 116a that includes rankings 120 of each PR. A process for identifying set of candidate PRs 116 is shown in FIG. 9, and a process for ranking set of candidate PRs 116 is shown in FIG. 10.

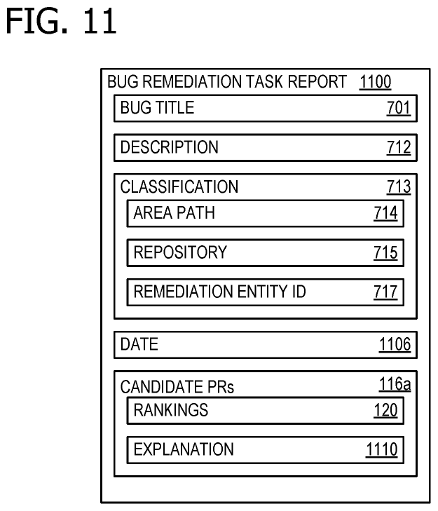

A final report generator 122 generates a bug remediation task report 1100, an example of which is shown in further detail in FIG. 11. Bug remediation task report 1100 is transmitted to a remediation entity 134 (across a network 1630, in some examples), and remediation entity 134 uses bug remediation task report 1100 to resolve reported bug 132. When reported bug 132 is resolved, a new software application 130a, without reported bug 132, is distributed to supersede software application 130.

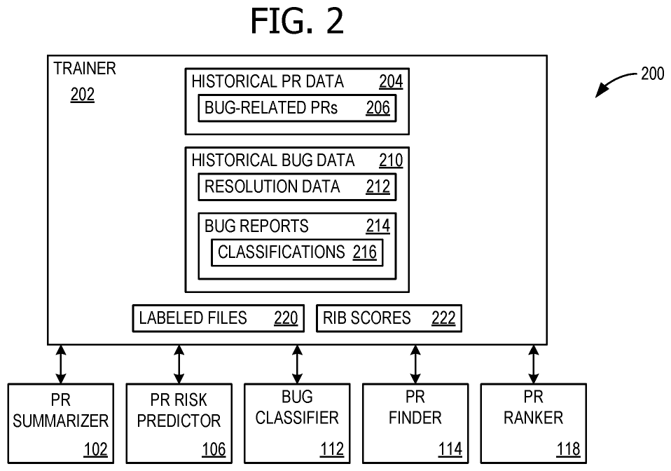

FIG. 2 illustrates an exemplary training arrangement 200 for components of architecture 100. In some examples, each of PR summarizer 102, PR risk predictor 106, bug classifier 112, PR finder 114, and PR ranker 118 comprises artificial intelligence (AI) or machine learning (ML), which are used synonymously herein.

A trainer 202 has access to historical PR data 204 (e.g., prior PRs) and historical bug data 210. Historical bug data 210 includes bug resolution data 212 and historical bug reports 214, at least some of which include classifications 216 of the bugs. Further description of a bug classification is provided in relation to FIG. 7. Trainer 202 uses historical PR data 204 and/or historical bug data 210 to train each of PR summarizer 102, PR risk predictor 106, bug classifier 112, PR finder 114, and PR ranker 118. In some examples, the training is ongoing, so that the performance of architecture 100 improves with continued use. Some example training operations are shown in FIGS. 4, 6, 8, 9, and 10.

FIG. 3 illustrates further detail for PR 300a. PR 300a has a PR title 301, a PR description 302, a classification 303 that includes an area path 304 and/or a repository 305, a merge date 306, a merge time 307 (e.g., a period of pendency of the PR, indicating a slow or rushed process), an indication of a work item 308, an indication of changed files 309, file characteristics 310 (e.g., file size, file complexity, churn, and file ownership), a count of affected files 311, an indication of changed code 312, a count of lines of code 313, a count of commits 314, a count of reviewers 315, and a count of comments 316. Some PRs may have additional or less content.

FIG. 4 illustrates a flowchart 400 of exemplary operations for generating PR summary 500. PR title 301, PR description 302, indication of changed files 309, indication of changed code 312, indication of a work item 308, and classification 303 are received as input in operation 402. Preprocessing with natural language processing (NLP) is performed in operation 404 to remove noise, normalize, and extract features, and operation 406 performs vectorization to represent text and code as numerical vectors.

Encode is performed using generative AI to learn a latent representation of the input, in operation 408, and operation 410 performs decoding using generative AI to generate PR summary 500. Postprocessing with NLP restore grammar, readability and coherence in operation 412. PR summary 500 is output as text operation 414 and stored in PR database 110 in operation 416. Operations 418 and 420 are ongoing training. Operation 418 evaluates metrics to measure quality, accuracy, and informativeness of PR summary 500, and operation 420 optimizes PR summarizer 102 by minimizing a loss function or maximizing a reward function.

FIG. 5 illustrates further detail for PR summary 500. PR summary 500 has a summary title 501 (which may be derived from PR title 301), a description 502 (which may be derived from PR description 302) and an identification 503 of the subject PR. Various information may be imported from the subject PR, such as classification 303 (including includes area path 304 and/or repository 305), merge date 306, merge time 307, indication of a work item 308, indication of changed files 309, file characteristics 310, count of affected files 311, indication of changed code 312, count of lines of code 313, a count of commits 314, count of reviewers 315, and count of comments 316. Some PR summaries may have additional or less content.

FIG. 6 illustrates a flowchart 600 of exemplary operations for generating a PR risk score (e.g., risk score 108). Operation 602 extracts PR features from new PRs, and operation 604 assigns risk of introducing a bug (RIB) scores to files in new PRs using a code clone risk prediction model (CCPM) and a code smell risk prediction model (CSPM). PRs and RIB scores are input to PR risk predictor 106 in operation 606, which generates an aggregate risk score for the PR (e.g., risk score 108) in operation 608. Operation 610 performs decoding using generative AI to generate PR summary 500.

Operation 612-640 are part of the ongoing training of PR risk predictor 106. Operation 612 identifies bug fix PRs, and operation 614 label files of the bug fix PRs with code clone and code smell labels. Operation 616 assigns RIB scores to the files of the bug fix PRs, and operation 618 generates labeled ground truth data sets. Operation 620 performs chronological partitioning of the files into training and test sets, and operation 622 inputs the training set files to CCPM and CSPM. Operation 624 predicts RIB scores for CCPM and CSPM, and operation 626 uses the predicted RIB scores and the ground truth to evaluate CCPM and CSPM performance.

Operation 632 extracts PR features from historical PRs, operation 634 adjusts PR features using bug fix labels, and operation 636 generates or updates PR risk predictor 106. Operation 638 uses PR risk predictor 106 to predict risks of merging PRs, and operation 640 evaluates the performance of PR risk predictor 106.

FIG. 7 illustrates further detail for bug report 700 and bug summary 710. Bug report 700 has a bug title 701, a bug description 702, and a date 706 of bug report 700 (e.g., report creation date or the earliest date that reported bug 132 was encountered). Bug description 702 may include code snippets, screenshots, and/or logs. Bug classifier 112 adds some information (as shown in FIG. 8), to produce bug summary 710 from bug report.

In some examples, bug summary 710 has a description 712 (that may be derived from or a copy of bug description 702), a date 716 (which may be a date of bug summary 710 or date 706), and a bug classification 713 (a classification of reported bug 132). Bug classification 713 has an area path 714 and/or a repository 715 that bug classifier 112 predicts will be the location of the PR that caused reported bug 132. In some examples, bug classification 713 also has a remediation entity identification 717 that identifies remediation entity 134 as the development team to resolve reported bug 132, based on the expected familiarity of remediation entity 134 with the PR that caused reported bug 132.

FIG. 8 illustrates a flowchart 800 of exemplary operations for determining a bug classification (e.g., bug classification 713). Bug title 701 and bug description 702 or description 712 are received in operation 802. Operation 804 performs preprocessing and vectorization on them using NLP. Operation 806 extracts keywords, topics, and entities using NLP, and operation 808 provides the extracted and vectorized features to the ML model of bug classifier 112. Operation 810 recommends (predicts) area path 714 and/or repository 715.

Operations 812 and 814 are related to ongoing training of bug classifier 112. Operation 812 compares the recommendation area path and repository with the actual area path and repository, when (if) the actual area path and repository become known. Operation 814 evaluates the accuracy and recall of bug classifier 112.

Operation 816 returns area path 714 and repository 715 as output, which are stored in historical bug data 210 in operation 818. Operation 820 updates bug classifier 112 with the new area path 714 and repository 715 for reported bug 132.

FIG. 9 illustrates a flowchart 900 of exemplary operations for identifying set of candidate PRs 116 that may have caused reported bug 132. PR finder 114 queries PR database 110 for PR data matching bug summary 710 in operation 902 and retrieves PR summaries and risk scores in operation 904. PR finder 114 identifies the PRs with the highest risk scores in operation 906 and sorts by merge dates in operation 908.

FIG. 10 illustrates a flowchart 1000 of exemplary operations for ranking set of candidate PRs 116 as to the likelihood of having caused reported bug 132. Bug summary 710, PR summaries 500 of set of candidate PRs 116, and their associated risk scores 108 are received in operation 1002. Operation 1004 performs preprocessing on them with NLP to normalize bug summary 710 and PR summaries 500 of set of candidate PRs 116. Operation 1006 vectorizes bug summary 710 and PR summaries 500 of set of candidate PRs 116.

Operation 1008 determines similarities between bug summary 710 and each PR summary 500 of set of candidate PRs 116 and assigns a similarity score to each. Operation 1010 normalizes the similarity and risk scores to the interval (0,1). Operation 1012 weights the normalized similarity and risk scores, which are combined in operation 1014. Operation 1016 optionally adjusts the combined scores by area path similarity (i.e., the similarity between area path 304 and area path 714). Operation 1018 sorts the scores in descending order, which are ranked according to the descending arrangement in operation 1020. Operation 1022 adds an explanation 1110 for each PR in ranked set of candidate PRs 116a.

FIG. 11 illustrates further detail for bug remediation task report 1100. Bug remediation task report 1100 includes information from bug summary 710, such as bug title 701, description 712, and bug classification 713. Bug remediation task report 1100 also has a date 1106, which may be the date of bug remediation task report 1100 or date 716. Bug remediation task report 1100 also includes ranked set of candidate PRs 116a that includes rankings 120 of each PR and explanation 1110 for why that PR is included and ranked the way it is.

Further descriptions for PR summarizer 102, PR risk predictor 106, PR database 110, bug classifier 112, PR finder 114, and PR ranker 118, applicable to some examples are provided:

PR summarizer 102 may be a generative AI model that generates a summary of the PR based on the PR title, description, changed files and code, linked work item, area path, and merge date. It takes as input a PR title, description, changed files and code, linked work item, area path, and merge date and outputs a summary of the PR. A linked work item is a reference to a bug, a feature, a task, or a user story that is associated with the PR. A merge date is the date when the PR is approved and merged into the main branch of the repository. PR summarizer 102 may be trained on a data set of historical PRs, their titles, descriptions, changed files and code, linked work items, area paths, and merge dates, which are extracted from a code hosting platform, such as GitHub, GitLab, or Bitbucket. PR summarizer 102 may use any suitable generative AI algorithm to generate concise and informative summaries of the PRs. PR summarizer 102 may also use any suitable NLP techniques, such as tokenization, stemming, lemmatization, parsing, or sentiment analysis, to preprocess and vectorize the PR input. PR summarizer 102 may generate summaries of the PRs that highlight the main changes, motivations, and impacts of the PRs, as well as the linked work item, the area path, and the merge date.

PR risk predictor 106 is a risk prediction engine that calculates the riskiness of merging a PR based on the RIB score of the files in the PR and the PR features (PRFs). The idea of PR risk predictor 106 is to use historical data, bug resolution data, and features of PRs to estimate the probability of a PR introducing a bug in the future. The historical data consists of the PRs that were merged in the past and the files that were modified or added as part of the PRs. The bug resolution data consists of the PRs that were merged to fix the bugs and the files that were changed or added to fix the bugs. The features of PRs are attributes that describe the PRs, such as the number of files, the number of lines of code, the number of commits, the number of reviewers, the number of comments, the approval status, the merge status, and/or the merge time. PR risk predictor 106 may use the following steps to generate an overall riskiness score of the PR, which may be a numerical value that reflects the probability of a PR causing a bug in the future.

PR risk predictor 106 labels the bug fixing PRs and the bug inducing files based on the bug resolution data. The bug fixing PRs are the PRs that were merged to fix the bugs, and the bug inducing files are the files that were changed or added to fix the bugs. PR risk predictor 106 also labels the files in the historical PRs with code clone labels and code smell labels, which are binary indicators that denote whether a file contains a code clone or a code smell or not. A code clone is a fragment of code that may be identical or similar to another fragment of code in the same or a different file. A code smell is a symptom of poor design or implementation that may indicate a deeper problem in the code, such as low cohesion, high coupling, long methods, or large classes. PR risk predictor 106 may use a code clone detection algorithm, such as CCFinder, and a code smell detection algorithm, such as PMD, to identify the code clones and the code smells in the historical PRs.

PR risk predictor 106 assigns an RIB score to each file in the historical PRs, which may be a numerical value that reflects the probability of a file causing a bug in the future, based on the code clone labels, the code smell labels, the bug inducing labels, and the file characteristics, such as the size, the complexity, the churn, or the ownership. PR risk predictor 106 may use a RIB score calculation algorithm, such as RiskCalc, to compute the RIB scores for the historical PRs. PR risk predictor 106 may use the bug inducing labels as a negative feedback signal to lower the RIB scores of the files that were cloned from or smelled like the bug inducing files, and as a positive feedback signal to increase the RIB scores of the files that were dissimilar from or free of code smells compared to the bug inducing files. PR risk predictor 106 then generates a labelled code clone risk inducing ground truth data set and a labelled code smell risk inducing ground truth data set, which are the historical PRs with the RIB scores and the bug inducing labels added.

PR risk predictor 106 may perform chronological partitioning on the labelled code clone risk inducing ground truth data set and the labelled code smell risk inducing ground truth data set, which splits the data sets into a training set and a testing set based on the merge dates. PR risk predictor 106 then inputs the training set to a CCPM and a CSPM, respectively, which are ML models that learn to predict the RIB scores for new files based on the historical data and the file features. PR risk predictor 106 may use any suitable ML algorithm to train and test the CCPM and the CSPM.

PR risk predictor 106 extracts PRFs from the historical PRs, which are features that describe the PRs, such as the number of files, the number of lines of code, the number of commits, the number of reviewers, the number of comments, the approval status, the merge status, or the merge time. PR risk predictor 106 may use the bug fixing labels as a negative feedback signal to lower the PRFs of the PRs that were similar to or correlated with the bug fixing PRs, and as a positive feedback signal to increase the PRFs of the PRs that were dissimilar from or independent of the bug fixing PRs. PR risk predictor 106 then generates a PR risk prediction model (PRPM), which may be an ML model that learns to predict the riskiness of merging a PR based on the RIB scores of the files in the PR from the CCPM and the CSPM, the PRFs, and the bug fixing labels. PR risk predictor 106 may use any suitable ML algorithm to train and test the PRPM.

PR risk predictor 106 generates an overall riskiness score of the PR, which may be a numerical value that reflects the probability of a PR introducing a bug in the future, based on the output of the PRPM. The importance of extracting PR features and using them in the model is that they may capture the contextual information and the quality aspects of the PRs that are not reflected by the file features alone. For example, the number of reviewers and the number of comments may indicate the level of peer review and feedback that the PR received, which may affect the quality and the correctness of the code changes. The approval status and the merge status may indicate the degree of agreement and consensus among the reviewers and the maintainers, which may affect the reliability and the stability of the code changes. The merge time may indicate the timeliness and the urgency of the PR, which may affect the trade-off between quality and speed. By incorporating the PR features into the model, PR risk predictor 106 may leverage the additional information and the quality signals that the PR features provide, and improve the accuracy and the robustness of the risk prediction.

PR database 110 is a storage location for PR summaries 500, area paths, merge dates, repositories, and the PR risk scores. PR database 110 may use any suitable data structure and format, such as a relational database, a document database, a graph database, or a JSON file, to store and organize the PR data.

Bug classifier 112 may be an ML model that predicts the area path and repository for the bug based on the bug title and description. An area path is a hierarchical classification of a work item by its functional or logical group which usually belongs to different owning teams. Bug classifier 112 may be trained on a data set of historical bugs, their area paths, and repositories, which are extracted from a bug tracking system, such as Azure DevOps, Jira, or GitHub Issues. Bug classifier 112 may use any suitable ML algorithm, such as a decision tree, a neural network, a support vector machine, or a random forest. Bug classifier 112 may also use any suitable NLP techniques, such as tokenization, stemming, lemmatization, parsing, or sentiment analysis, to preprocess and vectorize the bug title and description. Bug classifier 112 may handle different types of bug descriptions, such as natural language, code snippets, screenshots, or logs, and may extract relevant keywords, topics, or entities from them. Bug classifier 112 may achieve high accuracy and recall in predicting the area path and repository for a given bug, based on the historical data and the features of the bug.

PR finder 114 uses bug classifier 112 to identify the most likely area path and repository for the bug and searches for PRs merged before the bug creation date in that repository. PR finder 114 uses the output of Bug classifier 112 as the input for the area path and repository. PR finder 114 then queries PR database 110 for PR summaries 500 and the PR risk scores 108 that match the area path and repository and have a merge date earlier than the bug creation date. PR finder 114 may use any suitable query language and retrieval method, such as SQL, NoSQL, SPARQL, or Boolean logic, to search and filter the PR data.

PR ranker 118 ranks the PRs by their semantic similarity to the bug description and their PR risk scores and gives preference to PRs under the same area path. PR ranker 118 may use NLP, Generative AI and/or large language models (LLMs) to measure the semantic similarity between the bug summary and PR summaries 500, such as the cosine similarity, the Jaccard similarity, the Levenshtein distance, or the word mover's distance. PR ranker 118 may also use any suitable weighting or scoring function, such as TF-IDF, PageRank, BM25, or Okapi, to combine the semantic similarity and the PR risk scores into a single ranking score. PR ranker 118 outputs a list of possible bug-inducing PRs ordered by likelihood, with an explanation for each choice. The explanation may include the ranking score, the similarity score, the PR risk score, the area path, the merge date, and the summary of the PR.

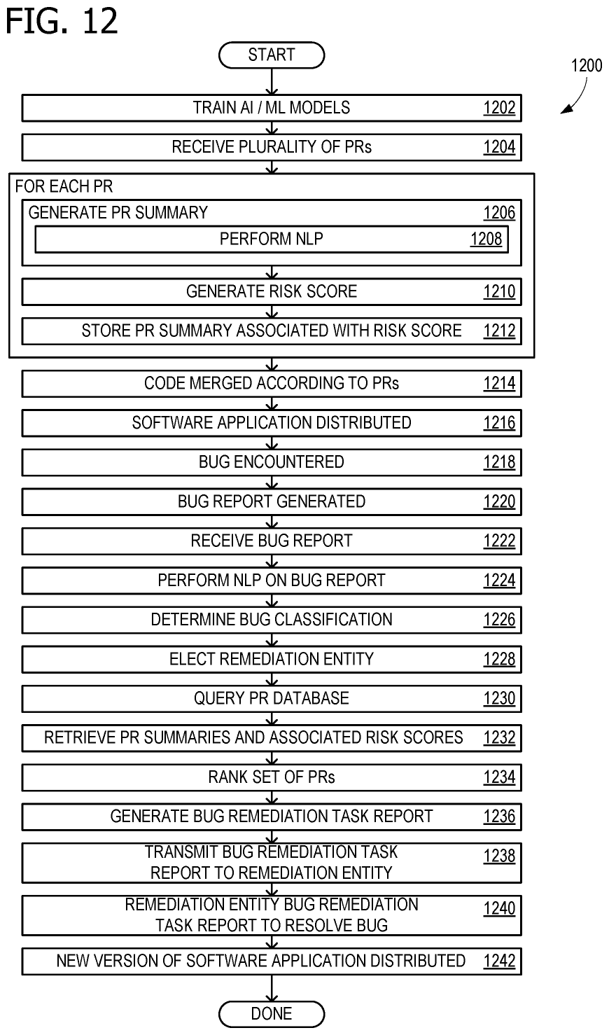

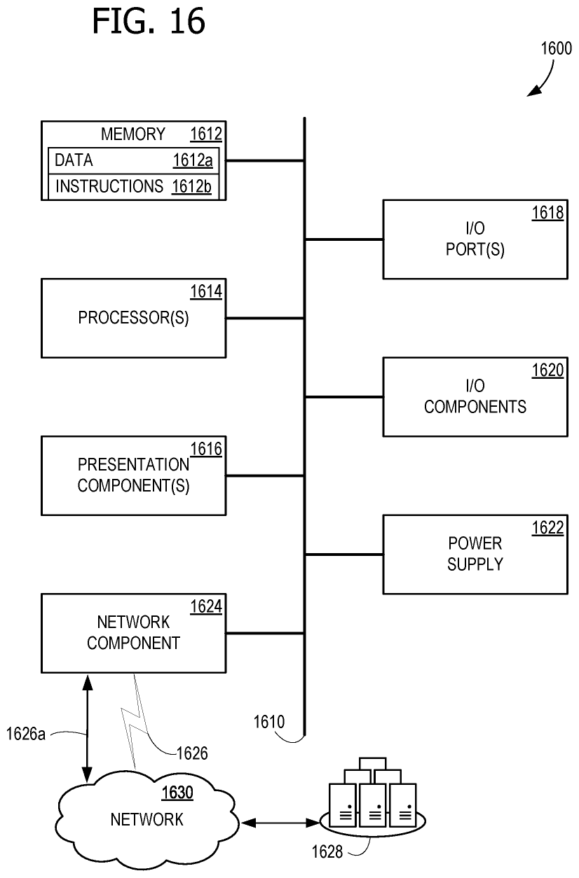

FIG. 12 shows a flowchart 1200 illustrating exemplary operations that may be performed by architecture 100. In some examples, operations described for flowchart 1200 are performed by computing device 1600 of FIG. 16. Flowchart 1200 commences with training PR summarizer 102 using historical PR data 204, training PR risk predictor 106 using historical bug data 210 and historical PR data 204, training bug classifier 112 using historical bug data 210, and training PR ranker 118 using historical PR data 204 and historical bug data 210 in operation 1202.

Plurality of PRs 300 is received in operation 1204, and operations 1206-1212 are performed for each PR of plurality of PRs 300. PR summarizer 102 generates a PR summary for a PR (e.g., PR summary 500 for PR 300a) in operation 1206. In some examples, this includes performing NLP to vectorize the PR in operation 1208. The NLP may further include normalization, such as tokenization, stemming, and/or lemmatization.

PR risk predictor 106 generates risk score 108 in operation 1210, using historical bug data 210 and historical PR data 204. Risk score 108 indicates a likelihood of the subject PR introducing a bug. In some examples, PR risk predictor 106 uses at least two features from among file characteristics 310, count of affected files 311, count of lines of code 313 in the PR, count of lines of commits 314, count of lines of reviewers 315, count of lines of comments 316, and merge time 307. In operation 1212, PR summary 500 and risk score 108 are stored in PR database 110, associated together.

Software code is merged according to the PRs in operation 1214, enabling production and distribution of software application 130 in operation 1216. Reported bug 132 is encountered in operation 1218, and bug report 700 is generated in operation 1220.

Bug classifier 112 receives bug report 700 for reported bug 132 in operation 1222. Bug classifier 112 performs NLP on bug report 700, such as normalization that may include tokenization, stemming, and/or lemmatization, in operation 1224. In operation 1226, bug classifier 112 determines bug classification 713 (e.g., area path 714 and/or repository 715) for reported bug 132 using at least bug report 700. This may include extracting keywords, topics, and/or entities from bug report 700. Bug classifier 112 also selects remediation entity 134 for reported bug 132, based on at least bug classification 713, in operation 1228.

In operation 1230, PR finder 114 queries PR database 110 to identify set of candidate PRs 116, having a potential association with reported bug 132, based on at least bug classification 713 of reported bug 132. This may include matching bug classification 713 of reported bug 132 with classification 303 of each PR in set of candidate PRs 116. Further, each PR in set of candidate PRs 116 may have merge date 306 earlier than date 706 of bug report 700.

PR summaries and their associated risk scores are retrieved from PR database 110 in operation 1232 for each PR in set of candidate PRs 116 (e.g., PR summary 500 and risk score 108 for PR 300a). In operation 1234, PR ranker 118 ranks set of candidate PRs 116 according to the likelihood of each PR of set of candidate PRs 116 having caused reported bug 132. In some examples, this includes finding a semantic similarity of PR summary 500 of each PR in set of candidate PRs 116 with bug report 700. In general, a PR having a same area path 304 as area path 714 of reported bug 132 is generally ranked higher in ranked set of candidate PRs 116a than a PR not having a same area path 304 as area path 714 of reported bug 132. In some examples, risk scores 108 are used in ranking set of candidate PRs.

Bug remediation task report 1100 is generated for reported bug 132 in operation 1236. In some examples, bug remediation task report 1100 identifies remediation entity 134 and/or includes explanation 1110 of why each PR is included in set of candidate PRs 116. Bug remediation task report 1100 is transmitted to remediation entity 134 in operation 1238, and in operation 1240, remediation entity 134 uses bug remediation task report 1100 to resolve reported bug 132. New version of software application 130a, with reported bug 132 resolved, is distributed to supersede the version of software application 130 that contained reported bug 132 in operation 1242.

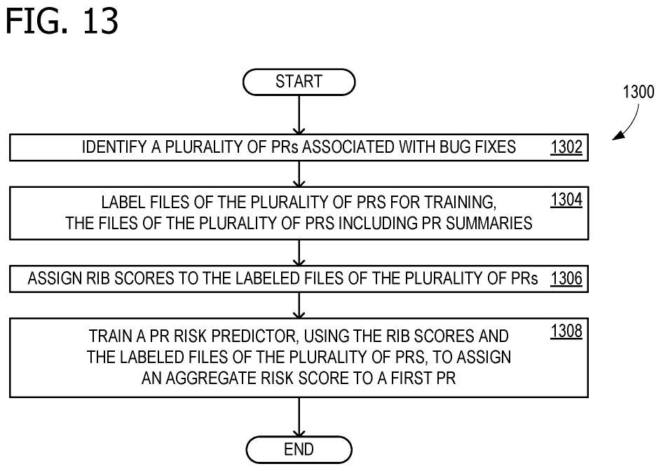

FIG. 13 shows a flowchart 1300 illustrating exemplary operations that may be performed by architecture 100. In some examples, operations described for flowchart 1300 are performed by computing device 1600 of FIG. 16. Flowchart 1300 commences with operation 1302, which includes identifying a plurality of PRs associated with bug fixes. Operation 1304 includes labeling files of the plurality of PRs for training, the files of the plurality of PRs including PR summaries. Operation 1306 includes assigning RIB scores to the labeled files of the plurality of PRs. Operation 1308 includes training a PR risk predictor, using the RIB scores and the labeled files of the plurality of PRs, to assign an aggregate risk score to a first PR.

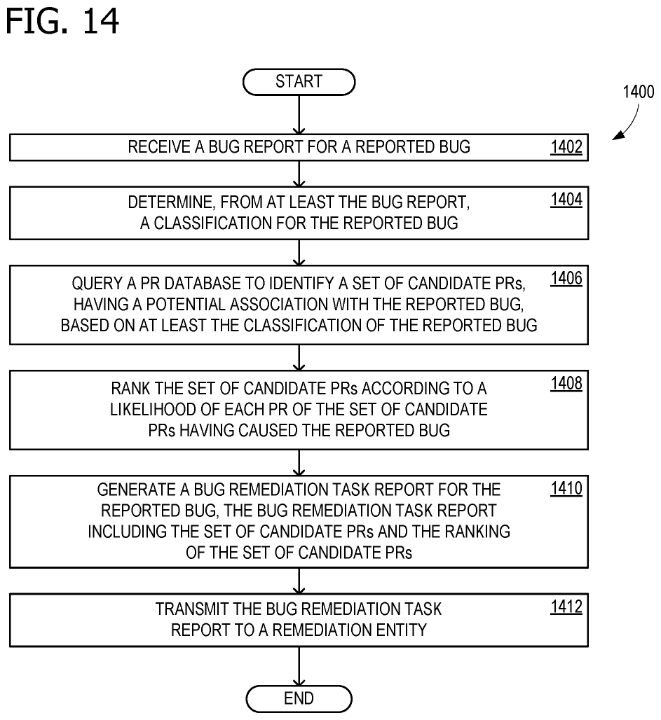

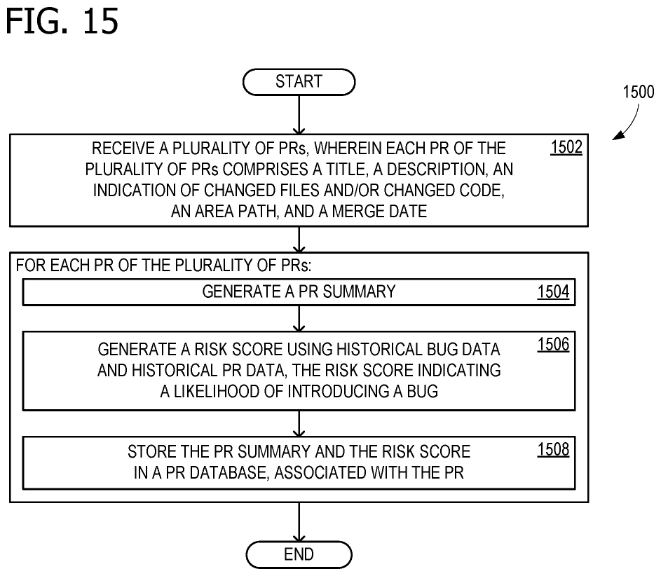

FIG. 14 shows a flowchart 1400 illustrating exemplary operations that may be performed by architecture 100. In some examples, operations described for flowchart 1400 are performed by computing device 1600 of FIG. 16. Flowchart 1400 commences with operation 1402, which includes receiving a bug report for a reported bug. Operation 1404 includes determining, from at least the bug report, a classification for the reported bug.

Operation 1406 includes querying a PR database to identify a set of candidate PRs, having a potential association with the reported bug, based on at least the classification of the reported bug. Operation 1408 includes ranking the set of candidate PRs according to a likelihood of each PR of the set of candidate PRs having caused the reported bug. Operation 1410 includes generating a bug remediation task report for the reported bug, the bug remediation task report including the set of candidate PRs and the ranking of the set of candidate PRs. Operation 1412 includes transmitting the bug remediation task report to a remediation entity.

FIG. 15 shows a flowchart 1500 illustrating exemplary operations that may be performed by architecture 100. In some examples, operations described for flowchart 1500 are performed by computing device 1600 of FIG. 16. Flowchart 1500 commences with operation 1502, which includes receiving a plurality of PRs, wherein each PR of the plurality of PRs comprises a title, a description, an indication of changed files and/or changed code, an area path, and a merge date.

Operations 1504-1508 are performed for each PR of the plurality of PRs. Operation 1504 includes generating a PR summary. Operation 1506 includes generating a risk score using historical bug data and historical PR data, the risk score indicating a likelihood of introducing a bug. Operation 1508 includes storing the PR summary and the risk score in a PR database, associated with the PR.

### ADDITIONAL EXAMPLES

An example system comprises: a processor; and a computer-readable medium storing instructions that are operative upon execution by the processor to: identify a plurality of PRs associated with bug fixes; label files of the plurality of PRs for training, the files of the plurality of PRs including PR summaries; assign RIB scores to the labeled files of the plurality of PRs; and train a PR risk predictor, using the RIB scores and the labeled files of the plurality of PRs, to assign an aggregate risk score to a first PR.

Another example system comprises: a processor; and a computer-readable medium storing instructions that are operative upon execution by the processor to: receive a bug report for a reported bug; determine, from at least the bug report, a classification for the reported bug; query a PR database to identify a set of candidate PRs, having a potential association with the reported bug, based on at least the classification of the reported bug; rank the set of candidate PRs according to a likelihood of each PR of the set of candidate PRs having caused the reported bug; generate a bug remediation task report for the reported bug, the bug remediation task report including the set of candidate PRs and the ranking of the set of candidate PRs; and transmit the bug remediation task report to a remediation entity.

Another example system comprises: a processor; and a computer-readable medium storing instructions that are operative upon execution by the processor to: receive a plurality of PRs, wherein each PR of the plurality of PRs comprises a title, a description, an indication of changed files and/or changed code, an area path, and a merge date; and for each PR of the plurality of PRs: generate a PR summary; generate a risk score using historical bug data and historical PR data, the risk score indicating a likelihood of introducing a bug; and store the PR summary and the risk score in a PR database, associated with the PR.

An example computer-implemented method comprises: identifying a plurality of PRs associated with bug fixes; labeling files of the plurality of PRs for training, the files of the plurality of PRs including PR summaries; assigning RIB scores to the labeled files of the plurality of PRs; and training a PR risk predictor, using the RIB scores and the labeled files of the plurality of PRs, to assign an aggregate risk score to a first PR.

Another example computer-implemented method comprises: identifying a plurality of PRs associated with bug fixes; labeling files of the plurality of PRs for training, the files of the plurality of PRs including PR summaries; assigning RIB scores to the labeled files of the plurality of PRs; and training a PR risk predictor, using the RIB scores and the labeled files of the plurality of PRs, to assign an aggregate risk score to a first PR.

Another example computer-implemented method comprises: receiving a plurality of PRs, wherein each PR of the plurality of PRs comprises a title, a description, an indication of changed files and/or changed code, an area path, and a merge date; and for each PR of the plurality of PRs: generating a PR summary; generating a risk score using historical bug data and historical PR data, the risk score indicating a likelihood of introducing a bug; and storing the PR summary and the risk score in a PR database, associated with the PR.

One or more example computer storage devices have computer-executable instructions stored thereon, which, on execution by a computer, cause the computer to perform operations comprising: receiving a bug report for a reported bug; determining, from at least the bug report, a classification for the reported bug; querying a PR database to identify a set of candidate PRs, having a potential association with the reported bug, based on at least the classification of the reported bug; ranking the set of candidate PRs according to a likelihood of each PR of the set of candidate PRs having caused the reported bug; generating a bug remediation task report for the reported bug, the bug remediation task report including the set of candidate PRs and the ranking of the set of candidate PRs; and transmitting the bug remediation task report to a remediation entity.

One or more example computer storage devices have computer-executable instructions stored thereon, which, on execution by a computer, cause the computer to perform operations comprising: determining, from at least the bug report, a classification for the reported bug; querying a PR database to identify a set of candidate PRs, having a potential association with the reported bug, based on at least the classification of the reported bug; ranking the set of candidate PRs according to a likelihood of each PR of the set of candidate PRs having caused the reported bug; generating a bug remediation task report for the reported bug, the bug remediation task report including the set of candidate PRs and the ranking of the set of candidate PRs; and transmitting the bug remediation task report to a remediation entity.

One or more example computer storage devices have computer-executable instructions stored thereon, which, on execution by a computer, cause the computer to perform operations comprising: receiving a plurality of PRs, wherein each PR of the plurality of PRs comprises a title, a description, an indication of changed files and/or changed code, an area path, and a merge date; and for each PR of the plurality of PRs: generating a PR summary; generating a risk score using historical bug data and historical PR data, the risk score indicating a likelihood of introducing a bug; and storing the PR summary and the risk score in a PR database, associated with the PR.

Alternatively, or in addition to the other examples described herein, examples include any combination of the following:
selecting the remediation entity for the reported bug, based on at least the classification of the reported bug;
the bug remediation task report identifies the remediation entity;
the bug report includes at least a bug title and a bug description for the reported bug;
the classification for the reported bug includes an area path and/or a repository;
a bug classifier determines the classification for the reported bug;
the bug classifier comprises AI;
a PR ranker ranks the set of candidate PRs;
the PR ranker comprises AI;
training the bug classifier using historical bug data that includes historical bug reports and their corresponding classifications;
training the PR ranker using historical PR data and the historical bug data;
identifying the set of candidate PRs comprises matching the classification of the reported bug with a classification of each PR in the set of candidate PRs;
each PR in the set of candidate PRs has an associated risk score that is used in ranking the set of candidate PRs;
ranking the set of candidate PRs comprises finding a semantic similarity of a PR summary of each PR in the set of candidate PRs with the bug report;
performing NLP on the bug report;
the NLP includes normalization, and wherein the normalization includes tokenization, stemming, and/or lemmatization;
the bug report includes code snippets, screenshots, and/or logs;
determining the classification for the reported bug includes extracting keywords, topics, and/or entities from the bug report;
each PR in the set of candidate PRs has a merge date earlier than a date of the bug report;
a PR having a same area path as the area path of the reported bug is generally ranked higher in the set of candidate PRs than a PR not having a same area path as the area path of the reported bug;
the bug remediation task report includes an explanation of why each PR is included in the set of candidate PRs;
the remediation entity uses the bug remediation task report to resolve the reported bug;
retrieving, for a first PR, the PR summary and the risk score from the PR database;
including the first PR in a set of candidate PRs;
ranking the first PR, among a set of candidate PRs, according to a likelihood of having caused a reported bug, using at least the PR summary and the risk score of the first PR;
including the set of candidate PRs and the ranking of the set of candidate PRs in a bug remediation task report for the reported bug;
transmitting the bug remediation task report to a remediation entity;
a PR summarizer generates the PR summary;
the PR summarizer comprises AI;
training the PR summarizer using the historical PR data;
performing NLP to vectorize the PR;
the NLP includes normalization;
the normalization includes tokenization, stemming, and/or lemmatization;
a PR risk predictor generates the risk score;
the PR summarizer comprises AI;
generating the risk score comprises using at least two features selected from file characteristics, a count of affected files, a count of lines of code in the PR, a count of commits, a count of reviewers, a count of comments, and a merge time;
the PR summary includes an indication of a work item, an area path, and a merge date;
the historical bug data includes bug resolution data;
each PR of the plurality of PRs further comprises an indication of a work item referencing a bug, or a feature, or a task, or a user story, and file characteristics; and
the file characteristics include file size, file complexity, churn, and file ownership.

While the aspects of the disclosure have been described in terms of various examples with their associated operations, a person skilled in the art would appreciate that a combination of operations from any number of different examples is also within scope of the aspects of the disclosure.

### Example Operating Environment

FIG. 16 is a block diagram of an example computing device 1600 (e.g., a computer storage device) for implementing aspects disclosed herein, and is designated generally as computing device 1600. In some examples, one or more computing devices 1600 are provided for an on-premises computing solution. In some examples, one or more computing devices 1600 are provided as a cloud computing solution. In some examples, a combination of on-premises and cloud computing solutions are used. Computing device 1600 is but one example of a suitable computing environment and is not intended to suggest any limitation as to the scope of use or functionality of the examples disclosed herein, whether used singly or as part of a larger set.

Neither should computing device 1600 be interpreted as having any dependency or requirement relating to any one or combination of components/modules illustrated. The examples disclosed herein may be described in the general context of computer code or machine-useable instructions, including computer-executable instructions such as program components, being executed by a computer or other machine, such as a personal data assistant or other handheld device. Generally, program components including routines, programs, objects, components, data structures, and the like, refer to code that performs particular tasks, or implement particular abstract data types. The disclosed examples may be practiced in a variety of system configurations, including personal computers, laptops, smart phones, mobile tablets, hand-held devices, consumer electronics, specialty computing devices, etc. The disclosed examples may also be practiced in distributed computing environments when tasks are performed by remote-processing devices that are linked through a communications network.

Computing device 1600 includes a bus 1610 that directly or indirectly couples the following devices: computer storage memory 1612, one or more processors 1614, one or more presentation components 1616, input/output (I/O) ports 1618, I/O components 1620, a power supply 1622, and a network component 1624. While computing device 1600 is depicted as a seemingly single device, multiple computing devices 1600 may work together and share the depicted device resources. For example, memory 1612 may be distributed across multiple devices, and processor(s) 1614 may be housed with different devices.

Bus 1610 represents what may be one or more buses (such as an address bus, data bus, or a combination thereof). Although the various blocks of FIG. 16 are shown with lines for the sake of clarity, delineating various components may be accomplished with alternative representations. For example, a presentation component such as a display device is an I/O component in some examples, and some examples of processors have their own memory. Distinction is not made between such categories as “workstation,” “server,” “laptop,” “hand-held device,” etc., as all are contemplated within the scope of FIG. 16 and the references herein to a “computing device.” Memory 1612 may take the form of the computer storage media referenced below and operatively provide storage of computer-readable instructions, data structures, program modules and other data for the computing device 1600. In some examples, memory 1612 stores one or more of an operating system, a universal application platform, or other program modules and program data. Memory 1612 is thus able to store and access data 1612a and instructions 1612b that are executable by processor 1614 and configured to carry out the various operations disclosed herein. Thus, computing device 1600 comprises a computer storage device having computer-executable instructions 1612b stored thereon.

In some examples, memory 1612 includes computer storage media. Memory 1612 may include any quantity of memory associated with or accessible by the computing device 1600. Memory 1612 may be internal to the computing device 1600 (as shown in FIG. 16), external to the computing device 1600 (not shown), or both (not shown). Additionally, or alternatively, the memory 1612 may be distributed across multiple computing devices 1600, for example, in a virtualized environment in which instruction processing is carried out on multiple computing devices 1600. For the purposes of this disclosure, “computer storage media,” “computer storage memory,” “memory,” and “memory devices” are synonymous terms for the memory 1612, and none of these terms include carrier waves or propagating signaling.

Processor(s) 1614 may include any quantity of processing units that read data from various entities, such as memory 1612 or I/O components 1620. Specifically, processor(s) 1614 are programmed to execute computer-executable instructions for implementing aspects of the disclosure. The instructions may be performed by the processor, by multiple processors within the computing device 1600, or by a processor external to the client computing device 1600. In some examples, the processor(s) 1614 are programmed to execute instructions such as those illustrated in the flow charts discussed below and depicted in the accompanying drawings. Moreover, in some examples, the processor(s) 1614 represents an implementation of analog techniques to perform the operations described herein. For example, the operations may be performed by an analog client computing device 1600 and/or a digital client computing device 1600. Presentation component(s) 1616 present data indications to a user or other device. Exemplary presentation components include a display device, speaker, printing component, vibrating component, etc. One skilled in the art will understand and appreciate that computer data may be presented in a number of ways, such as visually in a graphical user interface (GUI), audibly through speakers, wirelessly between computing devices 1600, across a wired connection, or in other ways. I/O ports 1618 allow computing device 1600 to be logically coupled to other devices including I/O components 1620, some of which may be built in. Example I/O components 1620 include, for example but without limitation, a microphone, joystick, game pad, satellite dish, scanner, printer, wireless device, etc.

Computing device 1600 may operate in a networked environment via the network component 1624 using logical connections to one or more remote computers. In some examples, the network component 1624 includes a network interface card and/or computer-executable instructions (e.g., a driver) for operating the network interface card. Communication between the computing device 1600 and other devices may occur using any protocol or mechanism over any wired or wireless connection. In some examples, network component 1624 is operable to communicate data over public, private, or hybrid (public and private) using a transfer protocol, between devices wirelessly using short range communication technologies (e.g., near-field communication (NFC), Bluetooth™ branded communications, or the like), or a combination thereof. Network component 1624 communicates over wireless communication link 1626 and/or a wired communication link 1626a to a remote resource 1628 (e.g., a cloud resource) across network 1630. Various different examples of communication links 1626 and 1626a include a wireless connection, a wired connection, and/or a dedicated link, and in some examples, at least a portion is routed through the internet.

Although described in connection with an example computing device 1600, examples of the disclosure are capable of implementation with numerous other general-purpose or special-purpose computing system environments, configurations, or devices. Examples of well-known computing systems, environments, and/or configurations that may be suitable for use with aspects of the disclosure include, but are not limited to, smart phones, mobile tablets, mobile computing devices, personal computers, server computers, hand-held or laptop devices, multiprocessor systems, gaming consoles, microprocessor-based systems, set top boxes, programmable consumer electronics, mobile telephones, mobile computing and/or communication devices in wearable or accessory form factors (e.g., watches, glasses, headsets, or earphones), network PCs, minicomputers, mainframe computers, distributed computing environments that include any of the above systems or devices, virtual reality (VR) devices, augmented reality (AR) devices, mixed reality devices, holographic device, and the like. Such systems or devices may accept input from the user in any way, including from input devices such as a keyboard or pointing device, via gesture input, proximity input (such as by hovering), and/or via voice input.

Examples of the disclosure may be described in the general context of computer-executable instructions, such as program modules, executed by one or more computers or other devices in software, firmware, hardware, or a combination thereof. The computer-executable instructions may be organized into one or more computer-executable components or modules. Generally, program modules include, but are not limited to, routines, programs, objects, components, and data structures that perform particular tasks or implement particular abstract data types. Aspects of the disclosure may be implemented with any number and organization of such components or modules. For example, aspects of the disclosure are not limited to the specific computer-executable instructions, or the specific components or modules illustrated in the figures and described herein. Other examples of the disclosure may include different computer-executable instructions or components having more or less functionality than illustrated and described herein. In examples involving a general-purpose computer, aspects of the disclosure transform the general-purpose computer into a special-purpose computing device when configured to execute the instructions described herein.

By way of example and not limitation, computer readable media comprise computer storage media and communication media. Computer storage media include volatile and nonvolatile, removable and non-removable memory implemented in any method or technology for storage of information such as computer readable instructions, data structures, program modules, or the like. Computer storage media are tangible and mutually exclusive to communication media. Computer storage media are implemented in hardware and exclude carrier waves and propagated signals. Computer storage media for purposes of this disclosure are not signals per se. Exemplary computer storage media include hard disks, flash drives, solid-state memory, phase change random-access memory (PRAM), static random-access memory (SRAM), dynamic random-access memory (DRAM), other types of random-access memory (RAM), read-only memory (ROM), electrically erasable programmable read-only memory (EEPROM), flash memory or other memory technology, compact disk read-only memory (CD-ROM), digital versatile disks (DVD) or other optical storage, magnetic cassettes, magnetic tape, magnetic disk storage or other magnetic storage devices, or any other non-transmission medium that may be used to store information for access by a computing device. In contrast, communication media typically embody computer readable instructions, data structures, program modules, or the like in a modulated data signal such as a carrier wave or other transport mechanism and include any information delivery media.

The order of execution or performance of the operations in examples of the disclosure illustrated and described herein is not essential, and may be performed in different sequential manners in various examples. For example, it is contemplated that executing or performing a particular operation before, contemporaneously with, or after another operation is within the scope of aspects of the disclosure. When introducing elements of aspects of the disclosure or the examples thereof, the articles “a,” “an,” “the,” and “said” are intended to mean that there are one or more of the elements. The terms “comprising,” “including,” and “having” are intended to be inclusive and mean that there may be additional elements other than the listed elements. The term “exemplary” is intended to mean “an example of.” The phrase “one or more of the following: A, B, and C” means “at least one of A and/or at least one of B and/or at least one of C.”

Having described aspects of the disclosure in detail, it will be apparent that modifications and variations are possible without departing from the scope of aspects of the disclosure as defined in the appended claims. As various changes could be made in the above constructions, products, and methods without departing from the scope of aspects of the disclosure, it is intended that all matter contained in the above description and shown in the accompanying drawings shall be interpreted as illustrative and not in a limiting sense.

What is claimed is:

1. A system comprising:
a processor; and
a computer-readable medium storing instructions that are operative upon execution by the processor to:
identify a plurality of pull requests (PRs) associated with bug fixes;
label files of the plurality of PRs for training, the files of the plurality of PRs including PR summaries;
assign risk of introducing a bug (RIB) scores to the labeled files of the plurality of PRs; and
train a PR risk predictor, using the RIB scores and the labeled files of the plurality of PRs, to assign an aggregate risk score to a first PR.

2. The system of claim 1, wherein labeling the files of the plurality of PRs for training comprises labeling the files with code clone and code smell labels.

3. The system of claim 1, wherein the PR risk predictor comprises a code clone risk prediction model (CCPM) and a code smell risk prediction model (CSPM), and wherein the aggregate risk score comprises an aggregation of a CCPM RIB score and a CSPM RIB score.

4. The system of claim 3, wherein training the PR risk predictor comprises:
partitioning the labeled files of the plurality of PRs into a training set and a test set;
training the CCPM and the CSPM, using the training set, to predict RIB scores; and
evaluating performance of the CCPM and the CSPM using the test set.

5. The system of claim 1, wherein the instructions are further operative to:
train a PR finder, using the plurality of PRs, to identify a set of candidate PRs in a PR database, having a potential association with a reported bug.

6. The system of claim 5, wherein training the PR finder comprises training the PR finder to use at least a classification of a reported bug in a bug report to identify the set of candidate PRs.

7. The system of claim 1, wherein the instructions are further operative to:
receive a bug report for a reported bug;
determine, from at least the bug report, a classification for the reported bug;
query a PR database to identify a set of candidate PRs, having a potential association with the reported bug, based on at least the classification of the reported bug;
rank the set of candidate PRs according to a likelihood of each PR of the set of candidate PRs having caused the reported bug;
generate a bug remediation task report for the reported bug, the bug remediation task report including the set of candidate PRs and the ranking of the set of candidate PRs; and
transmit the bug remediation task report to a remediation entity.

8. A computer-implemented method comprising:
identifying a plurality of pull requests (PRs) associated with bug fixes;
labeling files of the plurality of PRs for training, the files of the plurality of PRs including PR summaries;
assigning risk of introducing a bug (RIB) scores to the labeled files of the plurality of PRs; and
training a PR risk predictor, using the RIB scores and the labeled files of the plurality of PRs, to assign an aggregate risk score to a first PR.

9. The method of claim 8, wherein labeling the files of the plurality of PRs for training comprises labeling the files with code clone and code smell labels.

10. The method of claim 8, wherein the PR risk predictor comprises a code clone risk prediction model (CCPM) and a code smell risk prediction model (CSPM), and wherein the aggregate risk score comprises an aggregation of a CCPM RIB score and a CSPM RIB score.

11. The method of claim 10, wherein training the PR risk predictor comprises:
partitioning the labeled files of the plurality of PRs into a training set and a test set;
training the CCPM and the CSPM, using the training set, to predict RIB scores; and
evaluating performance of the CCPM and the CSPM using the test set.

12. The method of claim 8, further comprising:
training a PR finder, using the plurality of PRs, to identify a set of candidate PRs in a PR database, having a potential association with a reported bug.

13. The method of claim 12, wherein training the PR finder comprises training the PR finder to use at least a classification of a reported bug in a bug report to identify the set of candidate PRs.

14. The method of claim 8, further comprising:
receiving a bug report for a reported bug;
determining, from at least the bug report, a classification for the reported bug;
querying a PR database to identify a set of candidate PRs, having a potential association with the reported bug, based on at least the classification of the reported bug;
ranking the set of candidate PRs according to a likelihood of each PR of the set of candidate PRs having caused the reported bug;
generating a bug remediation task report for the reported bug, the bug remediation task report including the set of candidate PRs and the ranking of the set of candidate PRs; and
transmitting the bug remediation task report to a remediation entity.

15. A computer storage device having computer-executable instructions stored thereon, which, on execution by a computer, cause the computer to perform operations comprising:
identifying a plurality of pull requests (PRs) associated with bug fixes;
labeling files of the plurality of PRs for training, the files of the plurality of PRs including PR summaries;
assigning risk of introducing a bug (RIB) scores to the labeled files of the plurality of PRs; and
training a PR risk predictor, using the RIB scores and the labeled files of the plurality of PRs, to assign an aggregate risk score to a first PR.

16. The computer storage device of claim 15, wherein labeling the files of the plurality of PRs for training comprises labeling the files with code clone and code smell labels.

17. The computer storage device of claim 15, wherein the PR risk predictor comprises a code clone risk prediction model (CCPM) and a code smell risk prediction model (CSPM), and wherein the aggregate risk score comprises an aggregation of a CCPM RIB score and a CSPM RIB score.

18. The computer storage device of claim 17, wherein training the PR risk predictor comprises:
partitioning the labeled files of the plurality of PRs into a training set and a test set;
training the CCPM and the CSPM, using the training set, to predict RIB scores; and
evaluating performance of the CCPM and the CSPM using the test set.

19. The computer storage device of claim 15, wherein the operations further comprise:
training a PR finder, using the plurality of PRs, to identify a set of candidate PRs in a PR database, having a potential association with a reported bug, wherein training the PR finder comprises training the PR finder to use at least a classification of a reported bug in a bug report to identify the set of candidate PRs.

20. The computer storage device of claim 15, wherein the operations further comprise:
receiving a bug report for a reported bug;
determining, from at least the bug report, a classification for the reported bug;
querying a PR database to identify a set of candidate PRs, having a potential association with the reported bug, based on at least the classification of the reported bug;
ranking the set of candidate PRs according to a likelihood of each PR of the set of candidate PRs having caused the reported bug;
generating a bug remediation task report for the reported bug, the bug remediation task report including the set of candidate PRs and the ranking of the set of candidate PRs; and
transmitting the bug remediation task report to a remediation entity.
